(19) United States
(12) Patent Application Publication
(10) Pub. No.: US 2013/0152666 A1
(43) Pub. Date: Jun. 20, 2013

(54) Gas Chromatograph Column Markings to Determine Length

(71) Applicant: Scott T. Quarmby, Round Rock, TX (US)

(72) Inventor: Scott T. Quarmby, Round Rock, TX (US)

(21) Appl. No.: 13/326,083

(22) Filed: Dec. 14, 2011

(51) Int. Cl. G01N 1/00

(52) U.S. Cl. 73/23.41; 73/863

(57) ABSTRACT

A gas chromatograph column is marked with a code that allows an operator or machine to accurately determine the distance between two points on the column by comparing markings at the two points on the column. The code may be human or machine readable.

### BACKGROUND

To accurately and reproducibly set the flow a gas chromatograph (GC) column, its length must be known. The columns are manufactured to a known length but are trimmed or shortened during routine maintenance. Typical column lengths are between 5 and 90 m.

While the length of the column can be directly measured using a ruler, once wound on the support cage, it is not practical to measure in this manner. So most people assume the length is correctly determined by the manufacturer. Then, they keep track of how much is trimmed off of each end during routine maintenance. However, this method is prone to operator error in measurement or recordation.

Another method involves measuring the flow through the column for a given pressure difference across the column. Gas viscosity and temperature are known. However, to calculate length the internal diameter (ID) of the column must be known. This information is not available. The ID can be calculated when the length is known (when the column is new). This ID can then be used to solve for the length as the column is trimmed. However, if the ID is not determined or is lost this method cannot be used.

All of the aforementioned methods are prone to operator error in measurement or recordation.

### SUMMARY

The GC column is marked with a code that allows an operator or machine to accurately determine the length by comparing markings at the two points on the column. The markings are selected from a group including bar codes, dot patterns, and color scheme.

### BRIEF DESCRIPTION OF THE DRAWINGS

FIG. 1a illustrates an embodiment where the markings are positioned radially along the column. FIG. 1b illustrates an embodiment where the markings are axially positioned along the column.

FIG. 2 illustrates an embodiment where the markings are positioned in a spiral along the column.

FIG. 3 is flowchart according to the invention.

FIG. 4 illustrates the layers for the capillary column.

FIG. 5 illustrates an embodiment of FIG. 1 or 2 where the marking is a numerical code.

FIG. 6 is an illustrative example according to the flowchart shown in FIG. 3.

### DETAILED DESCRIPTION

The GC column is marked with a code that allows an operator or machine to accurately determine the distance between two points along the length of the column by comparing markings at the two points on the column. The distance between the two points could represent the length of the column.

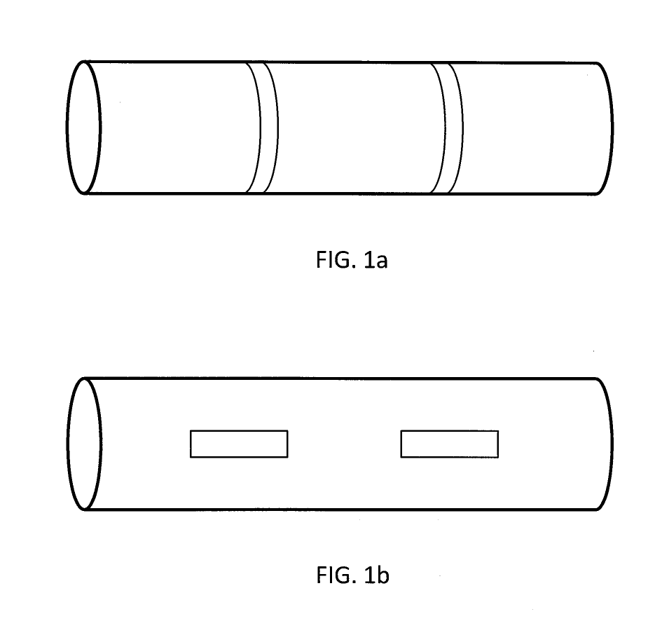

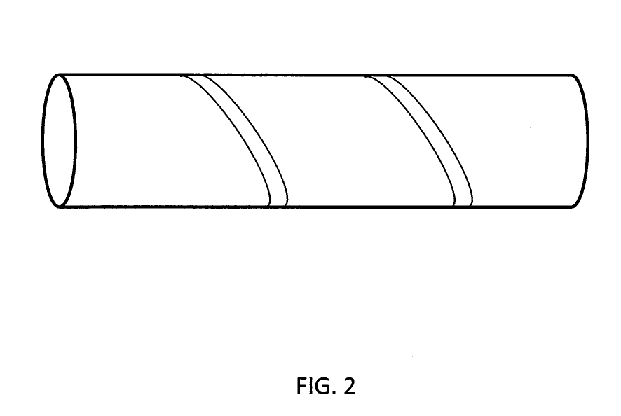

FIG. 1 a illustrates an embodiment where the markings are positioned radially along the column. FIG. 1b illustrates an embodiment where the markings are positioned axially along the column. FIG. 2 illustrates an embodiment where the markings are positioned in a spiral along the column.

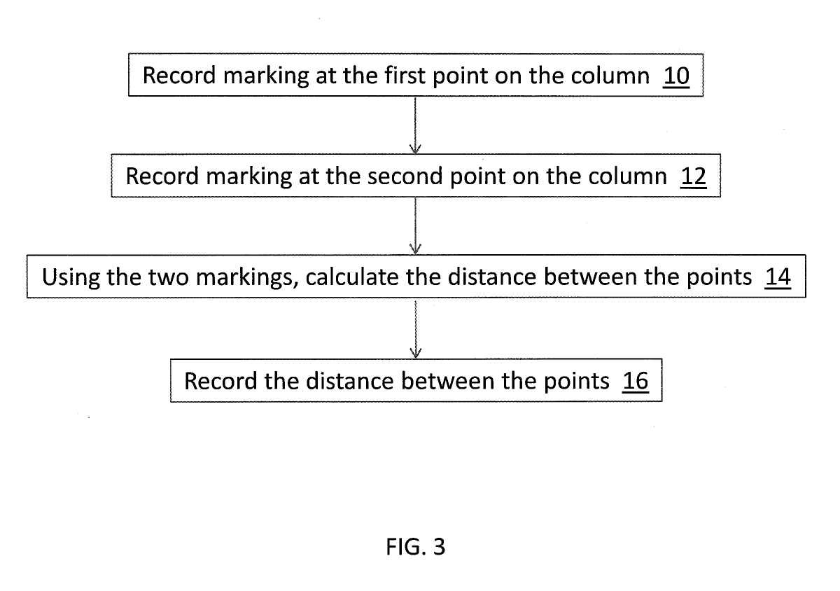

FIG. 3 is flowchart according to the invention. In step 10, the marking at the first point on the column is recorded. In step 12, the marking at the second point on the column is recorded. In step 14, the distance between the two points is calculated using the two markings. In step 16, the distance between the points is recorded.

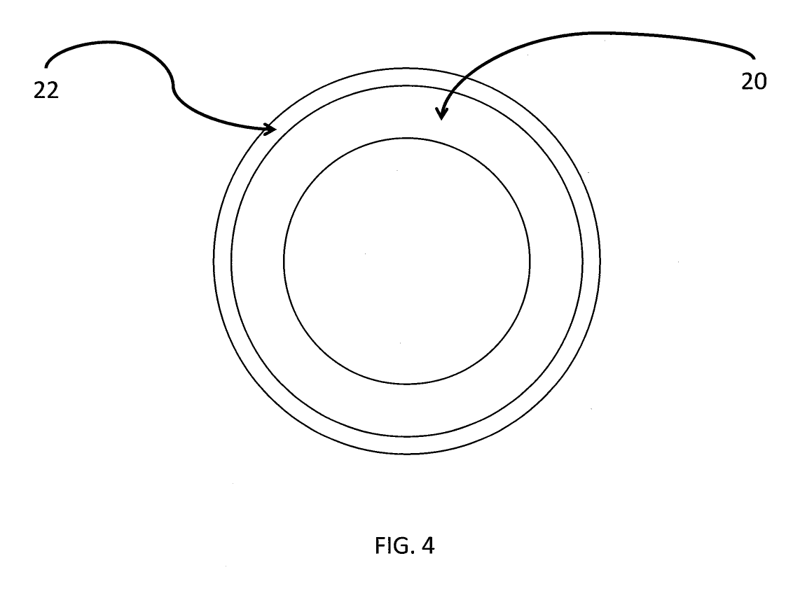

FIG. 4 illustrates the layers for the capillary column. The column is typically comprised of fused silica 20 encased by a polyimide or metal coating 22. The exterior may be marked with a high temperature ink. Typical polyimide coated columns have an upper operating temperature of 350° C. Metal coated columns have an upper operating temperature of 450° C. In an alternate embodiment, the exterior coating is laser etched. In another embodiment, the fused silica is marked with a high temperature ink and then encased by the polyimide coating. The polyimide coating is preferably transparent enough for operator or machine reading.

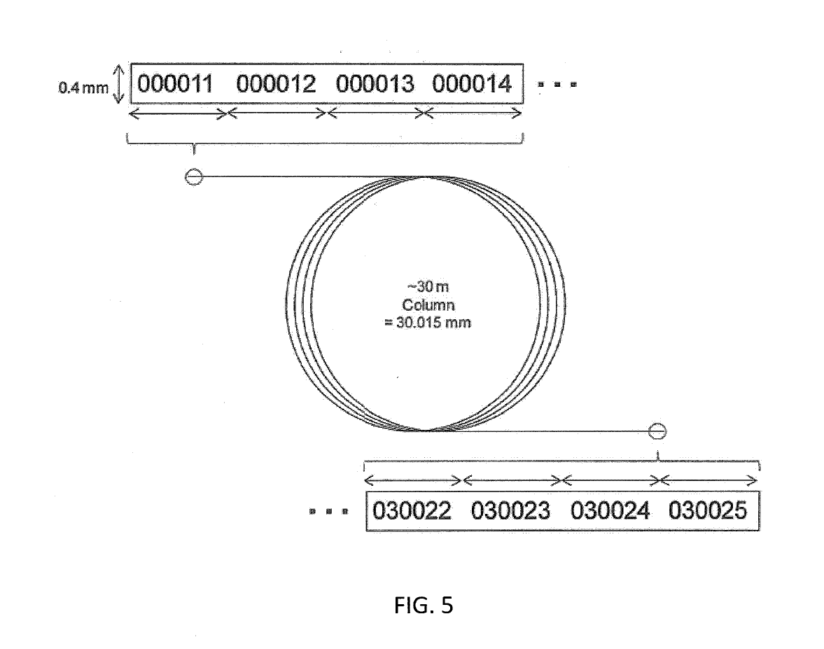

FIG. 5 illustrates an embodiment of FIG. 1a, FIG. 1b, or FIG. 2 where the marking is a human decipherable numerical code. This code represents the position in millimeters (mm). Millimeter precision is more than sufficient for the measurement of column length. When the code is six digits, column lengths of up to 1,000,000 mm or 1,000 m may be marked without repeating a number. Typical GC lengths are between 5 and 90 m.

To determine the column length, complete markings at the beginning and end of the column are read. Complete markings are ones which appear in their entirety and are not partially cut off. In FIG. 5, these marks are 000011 at the beginning and 030025 at the end. They are spaced by 1 mm. We subtract these two readings and add 1 mm to get 30015 mm or 30.015 m. We add 1 mm because we must account for the extra length at the beginning and end of the column because the markings are complete.

It is often desirable to measure the length of the entire column even though markings at the ends of the column are not visible. For example, the column may be installed in a GC where one end of the column is inserted into an injector, the other end in a detector. The total length can still be determined by measuring the distance between the points which are just outside the injector and detector. Then, add the distances the column is inserted into the injector and into the detector.

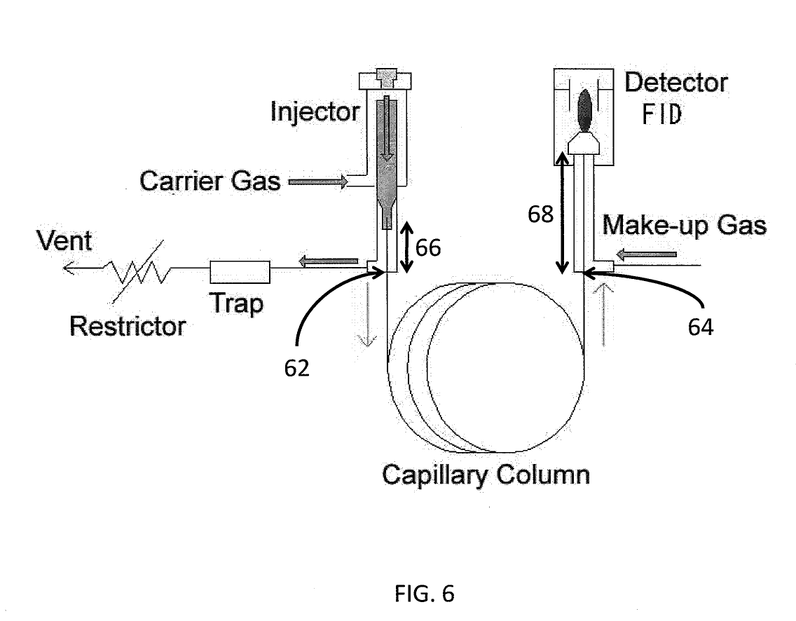

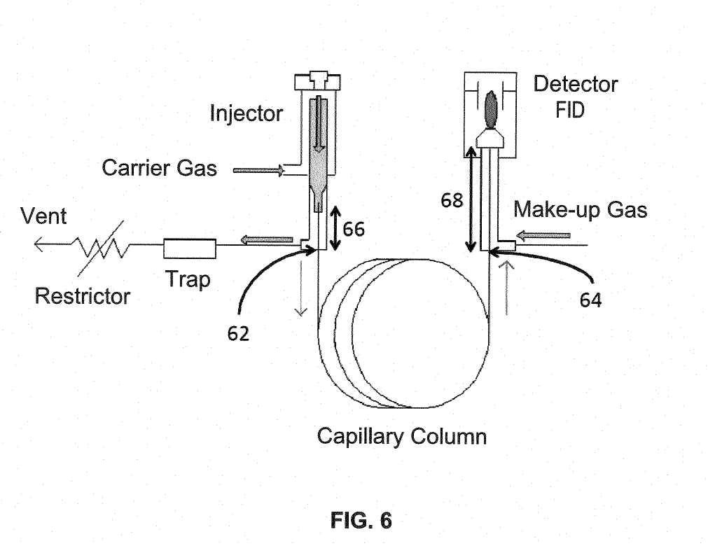

FIG. 6 is an illustrative example according to the flowchart shown in FIG. 3. In FIG. 6, first record the marking at the injector side 62. Then record the marking at the detector side 64. Calculate the distance between marking 62 and 64. To that distance, add the distance the column is inserted into the injector, 66, and add the distance the column is inserted into the detector, 68.

The code may further include column parameters, e.g. inner diameter (ID), phase, serial number, date of manufacture, maximum temperature.

In order to encode sufficient information in the code, a magnifying loop may be used. With 10 or 20×magnification, English letters as small as 0.2 mm tall are human readable.

While the invention has been described illustratively with a numerical code, the inventive concept can be extended to machine readable codes, e.g. one and multi-dimensional bar codes, dot patterns, color schemes.

I claim:

1. An assembly comprising:
capillary tubing; and
markings positioned on the tube, the markings being indicative of position.

2. An assembly as in claim 1, wherein the markings are machine-readable.

3. An assembly as in claim 1, wherein the markings are human decipherable.

4. An assembly as in claim 2, wherein the markings are selected from a group including bar codes, dot patterns, and color scheme.

5. An assembly, as in claim 1, the markings include indicators of column parameters of use and manufacture.

6. A system, as in claim 1, further comprising:
a gas chromatograph assembly including the capillary tubing.
